(19) United States
(12) Patent Application Publication
(10) Pub. No.: US 2013/0103357 A1
(43) Pub. Date: Apr. 25, 2013

(54) Method for recognizing and/or assessment of device and/or process related disturbances in a measurement signal

(71) Applicant: Endress + Hauser Conducta Gesellschaft fur Mess-und Regeltechnik mbH + Co. KG, Gerlingen (DE)

(72) Inventors: Edin Andelic, Stuttgart (DE); Matthias Grossmann, Vaihingen-Enz (DE); Carsten Gotz, Ettenheim (DE)

(73) Assignee: Endress + Hauser Conducta Gesellschaft fur Mess-und Regeltechnik mbH + Co.KG, Gerlingen (DE)

(21) Appl. No.: 13/652,913

(22) Filed: Oct. 16, 2012

(30) Foreign Application Priority Data
Oct. 17, 2011 (DE) 10 2011 084 636.0

(51) Int. Cl. G06F 17/00; G06F 17/16

(52) U.S. Cl. CPC G06F 17/00; G06F 17/16
USPC 702/189

(57) ABSTRACT

A method for recognizing and/or assessment of device and/or process related disturbances in a measurement signal, especially in a turbidity measurement of a fluid or gaseous medium with the steps of: generation of transmittable signals by means of at least one transmitter, wherein the transmitted signal is transformed through interaction with the medium, depending on the measurement variable, collection of measurement signals by means of at least one of the collectors assigned to the transmitter from the transformed transmission signals, characterized in that, the measurement signals are further processed by generating a distortion ratio of the measurement signal by processing the measurement signal with a distortion factor acquired from a dimensional reduction technique, especially principal component analysis (PCA), wherein the distortion factor takes into account the principal components with the largest contribution to the total variance, and assessing the distortion ratio over the course of time.

### TECHNICAL FIELD

The invention concerns a method for recognizing and/or assessment of device and/or process related disturbances in a measurement signal, especially in a turbidity measurement of a fluid or gaseous medium.

### BACKGROUND DISCUSSION

Turbidity measurements in the sense of this invention are conducted by means of a turbidity sensor in particular in fresh water and water for general purposes as well as gases. Furthermore, the invention is related to measurements of process variables such as, for example, solid content or sludge concentration. Measuring devices that are suitable for the determination of the respective process variables are proffered by the Endress+Hauser group of companies in a wide variety of products, as an example under the name “Turbimax CUS51 D”.

Normally, the sensors are arranged in a sensor body and the determination of the process variable occurs optically. Hereby, electromagnetic waves of at least one wavelength are transmitted, by at least one transmitter, through at least one optical window in the sensor body, are scattered by the measurement medium and are contingently collected by a collector via another optical window. The wavelength of the electromagnetic waves of the optical components is typically in the near infrared range, such as for example 880 nm.

Through operation in aqueous or gaseous media, especially in waste water as well, fouling, contaminations, accumulations and accretions accrue on the optical window, whereby measurement results are distorted. Often, a barely visible, grimy film develops on the window. The optical window can be damaged by abrasive media. There are short term contaminants, which after a time detach themselves from the optical window, as well as long term contaminants, which do not independently detach themselves from the optical window and permanently adhere to the optical window, A subtle error in the measurement signal thereby ensues.

A narrow band emitter, e.g. a light emitting diode (LED), is usually employed as a transmitter. The LED is thereby used to produce light in a suitable wavelength range. Accordingly, a photodiode can be employed as a collector, which produces a collector signal from the collected light, such as for example a photocurrent or a photo-voltage.

Light emitting diodes and photo diodes are liable to age induced variability in terms of their transmitting and collection properties. Due to this, the (emitting) performance can degrade or the photocurrent can be smaller than it was when the device was deployed. This is regarded as problematic for the determination of process variables given that an accurate measurement can thus no longer be guaranteed.

Hence, the active status of the measurement must be monitored and assessed. The assessment of the active status is essentially related to availability, security, and quality, wherefrom an assertion can be deduced as to the plausibility and reliability of the measured value.

In prognosticating the future status, the points in time at which a maintenance measure (calibration, cleaning, replacement of operational parts, such as for example an LED, renewing of consumables, replacing parts of the system or the whole system) will be required, are of interest.

A method for a control unit is known from DE 196 81 530 B4 that takes the residuum, of a difference between measurement signals and the estimated signals derived from a principal component analysis (PCA) of all principal components, as a standard measure of the quality of the measuring signal, wherein the residuum is calculated with a long algorithm comprising multiple steps and is accordingly a capacious computation.

### SUMMARY OF THE INVENTION

The object achieved by the present invention is the recognition and assessment of a distortion in the measurement signal in order to permanently guarantee an accurate measurement.

The object is achieved through a method with the steps of:
Generation of transmittable signals by means of at least one transmitter, wherein the transmitted signal is transformed through is interaction with the medium, depending on the measurement variable,
Collection of measurement signals by means of at least one of the collectors assigned to the transmitter from the transformed transmission signals characterized in that, the measurement signals are further processed by
Generating a distortion ratio of the measurement signal by processing the measurement signal with a distortion factor acquired from a dimensional reduction technique, especially principal component analysis (PCA), wherein the distortion factor takes into account the principal components with the largest contribution to the total variance, and
Assessing the distortion ratio over the course of time.

By using a dimensional reduction technique, especially principal component analysis (PCA), it is possible to generate a distortion ratio of the measurement signal. An assertion as to the quality of the measurement can be made by means of this distortion ratio. If the properties of a transmitter and/or a collector change, or if a contamination of the sensor is present, then this can be detected in the distortion ratio over the course of time.

In a preferred embodiment, the principal components with the n largest contributions to the total variance are used, where n is the number of transmitters. Circa 95% of the total variance is accounted for by the n largest (contributing) principal components.

In an advantageous embodiment the method also includes the output of a warning message if a threshold value for the distortion ratio is exceeded within a preset time frame. Thus, it can be responded to in a timely way, if the quality of measurement is no longer of the desired caliber.

Preferably, the distortion ratio \tilde{x} is computed with the equation

\tilde{x}=Sx

where,

S is the distortion factor and

x is the measurement signal.

Advantageously, the distortion factor S is computed with the equation

S=(I−PP^{T})

where,

I is the identity matrix and

P is the matrix composed from the principal components with the largest contributions to the total variance.

In a preferable embodiment, the principal component analysis (PCA) is conducted in advance with measurement signals ascertained under standard conditions.

In an advantageous embodiment, the measurement signals for at least one of the following media: formazine, activated sludge, digested sludge, primary sludge, return activated sludge, kaolin, or Titantium Dioxide (TiO₂) are used for the principal component analysis.

Given that the principal component analysis (PCA) is conducted in advance, i.e. before that actual measurement of the measuring medium, with a wide variety of media, the distortion factor from the principal component analysis (PCA) reflects and evinces the wide variety of these media. The processing of s the measurement signal of the measured medium with the distortion factor, and the generation of the distortion ratio, is based on a solid framework that spans the majority of the possible turbidity values. The distortion ratio is a reliable standard measure for the quality of the measurement.

If a predetermined threshold value for the distortion ratio is exceeded, then the previously mentioned warning or error message is output. This threshold value indicates that no longer do only the largest principal components contribute significant contributions to the total variance, rather, that the other principal components also provide significant contributions to the total is variance. The result of this circumstance is that the measurement no longer has the desired quality, e.g. because the collector is aging or contaminations are present.

In a preferred embodiment, the measurement signal is normalized, where

$${x}_{normalized} = \frac{x}{‖ x ‖} ,$$

before conducting the principal component analysis (PCA). Normalization of the measurement signal was shown to be advantageous, because a drifting of the measurement signal (due to, for example, a slowly growing contamination of the window) is thereby more easily recognized. It goes without saying that this normalization must also be performed on the actual, live measurement-signal as well.

In an advantageous embodiment, a microprocessor or a microcontroller conducts the computation of the distortion ratio. Microprocessors and controllers can reliably carry out the described computation at a low energy cost and are therefore suitable components.

### BRIEF DESCRIPTION OF THE DRAWING

The invention is described in detail with the help of the following figure. It shows:

FIG. 1: is a flow diagram of the inventive method.

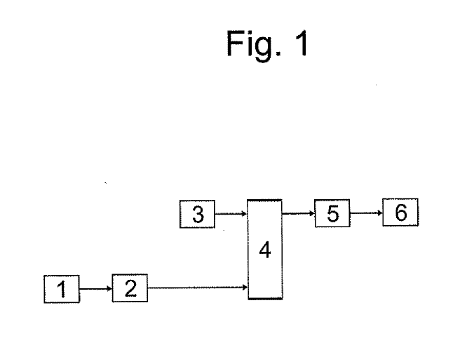

### DETAILED DESCRIPTION IN CONJUNCTION WITH THE DRAWING

The invention should be illustrated in terms of a turbidity measurement. The invention is, however, further applicable to measurements of similar process variables such as, perhaps, sludge concentration or solid content. In a turbidity sensor there are typically two independently functioning sensory units, each with one transmitter and two collectors. Preferably, the two collectors are used to collect scattered light at angles of 90° and 135° from the emitting direction of the transmitter, respectively. In a turbidity sensor, the 90° channel is primarily used for low levels of turbidity. The 135° channel is primarily used for mid- and high levels of turbidity as well as for solid content measurements. There are other known turbidity sensors which comprise only one collector and/or transmitter; the inventive method is also applicable to these sensors. The transmitter and collector are in contact with the measuring medium via one or more (optical) windows.

In the first step, the measurement signals are registered under standard conditions in Block 1. Standard conditions in the sense of this invention are constant temperature, constant air pressure, a medium of well-defined proportions and, in order to hold the turbidity constant, frequent stirring of the medium. The measurement signal of at least one of the media formazine, activated sludge, digested sludge, primary sludge, return activated sludge, kaolin, or Titantium Dioxide (TiO₂) is registered during the measurement under standard conditions in the laboratory.

In Block 2, a principal component analysis is generated out of these various measurement signals. The principal components emerge from this principal component analysis with heterogeneous contributions to the total variance. For the invention, only the principal components with the largest contributions to the total variance are decisive. In the example, the first two principal components have the largest contribution to the total variance, i.e. the effective dimensionality of the data is two. The effective dimensionality of the data is equal to the number of transmitters. It has been shown that 95% of the total variance can be mapped with the n largest principal components, where n is the number of transmitters.

In the next step, the measurement signals from the measured medium are registered in Block 3. These measurement signals from Block 3 are processed in Block 4 with the first two principal components from which emerges the distortion ratio of the signal, where

\tilde{x}=Sx wherein

\tilde{x} is the distortion ratio,

S is the distortion factor, and

x represents measurement signal. The distortion factor S is computed with the equation

S=(I−PP^{T}) wherein,

I is the identity matrix and

P is the matrix composed from the two principal components with the largest contributions to the total variance. The larger the distortion ratio, the larger the distortion is. If the contribution of the n largest (contributing) principal components falls (markedly) under 95%, or in other words, the distortion ratio is above a threshold value, then the other principal components also correspond to significant contributions to the total variance. The result of this is that the measurement no longer delivers the desired quality, because, by way of example, the collector/transmitter is aging or contaminations are present.

Given that, the matrix P is obtained beforehand, under standard conditions in the laboratory, only a multiplication must be conducted in the sensor. This computation can occur with the help of a micro controller or microprocessor. However, even simpler circuit element can be imagined, since the sensors, in some cases, must be operable at a low energy cost. So, the computation can take place in the sensor, or in principal can also be conducted outside of the sensor in a separate data processing unit.

The distortion ratio is subsequently assessed in Block 5. If the distortion ratio is greater than a certain threshold value, then a warning message can be output in Block 6. A multistage warning system is conceivable, wherein distinct warning messages are output according to the magnitude of the distortion ratio.

In summary, the most important principal components are obtained from a wide variety of media under standard conditions in the laboratory and then combined with the measured values from the measurement medium. The resultant value is a standard measure for the quality of the measurement. A warning or error message is output as needed.

1-9. (canceled)

10. A method for recognizing and/or assessment of device and/or process related disturbances in a measurement signal, especially in a turbidity measurement of a fluid or gaseous medium, comprising the steps of:
generation of transmittable signals by means of at least one transmitter, wherein the transmitted signal is transformed through interaction with the medium, depending on the measurement variable;
collection of measurement signals by means of at least one of the collectors assigned to the transmitter from the transformed transmission signals, wherein the measurement signals are further processed by:
generating a distortion ratio of the measurement signal by processing the measurement signal with a distortion factor acquired from a dimensional reduction technique, especially principal component analysis (PCA), wherein the distortion factor takes into account the principal components with the largest contribution to the total variance, and
assessing the distortion ratio over the course of time.

11. The method as claimed in claim 10, wherein:
the principal components with the n largest contributions to the total variance are used, where n is the number of transmitters.

12. The method as claimed in claim 10, further comprising the step of:
generating output of a warning message if a threshold value for the distortion ratio is exceeded within a preset time frame.

13. The method as claimed in claim 10, wherein:
the distortion ratio \tilde{x} is computed with the equation
\tilde{x}=Sx
where, S is the distortion factor and
x is the measurement signal.

14. The method as claimed in claim 10, wherein:
the distortion factor S is computed with the equation
S=(I−PP^{T})
where,
I is the identity matrix, and
P is the matrix composed from the principal components with the largest contributions to the total variance.

15. The method as claimed in claim 10, wherein:
the principal component analysis (PCA) is conducted in advance with measurement signals ascertained under standard conditions.

16. The method as claimed in claim 15, wherein:
the measurement signals for at least one of the following media: formazine, activated sludge, digested sludge, primary sludge, return activated sludge, kaolin, or Titantium Dioxide (TiO₂) are used for the principal component analysis.

17. The method as claimed in claim 10, wherein:
the measurement signal is normalized, where
$${x}_{normalized} = \frac{x}{‖ x ‖} ,$$
before conducting the principal component analysis.

18. The method as claimed in claim 10, wherein:
a microprocessor or a microcontroller conducts the computation of the distortion ratio.
